(19) United States
(12) Patent Application Publication
(10) Pub. No.: US 2007/0153080 A1
(43) Pub. Date: Jul. 5, 2007

(54) High-speed continuous film writer

(75) Inventors: Martin E. Oehlbeck, Rochester, NY (US); Richard L. Druzynski, East Rochester, NY (US)

Correspondence Address: Pamela R. Crocker, Patent Legal Staff;Eastman Kodak Company, 343 State Street, Rochester, NY, 14650-2201, US

(73) Assignee: Eastman Kodak Company

(21) Appl. No.: 11/321,344

(22) Filed: Dec. 29, 2005

(51) Int. Cl. B41J 2/435

(52) U.S. Cl. 347/224

(57) ABSTRACT

A high-speed writer suitable for continuous writing of data onto a photosensitive medium is disclosed. The system includes an illumination source having a plurality of individual colors. An illumination optical element distributes individual color onto distinct areas of the high-speed area array modulator, wherein each distinct area is proportionally related to the photosensitive medium's sensitivity to a corresponding color. A high-speed area array modulator rapidly modulates the plurality of individual colors in correspondence to the data on a pixel-by-pixel basis. An output optical element directs the modulated color light from the high-speed modulator onto the photosensitive medium; and a frame synchronization shifter synchronizes movement of the data to contiguous areas of the high-speed area array to the photosensitive medium while it is in continuous motion.

### FIELD OF THE INVENTION

This invention relates generally to a method for spatially and temporally modulating a light beam and more specifically to forming a high resolution image on photosensitive media using two-dimensional spatial light modulators. More specifically, this patent relates to high-speed recording of high-quality, high-resolution images onto photosensitive media, in particular images containing color.

### BACKGROUND OF THE INVENTION

One of the early methods used for digital printing onto movie film was a cathode ray tube (CRT) based system. In a CRT-based printer, the digital data is used to modulate the CRT, which provides exposure energy by scanning an electron beam of variable intensity along a phosphorescent screen. This technology has several limitations related to the phosphor and the electron beam. The resolution of this technology is limited to approximately 1000 pixels across the film, perforation to perforation, which roughly corresponds to 1000 DPI (dots per inch). CRT printers also tend to be expensive, which is a severe shortcoming in cost sensitive markets such as photo processing and film recording. An additional limitation is that CRT printers can only operate at rates of about one minute per frame. Although this may be acceptable for limited segments of the motion picture industry, such as special effects, it is far too slow for digital editing and enhancement of full-length feature films.

Another exemplary, but commonly used approach to digital printing is shown in U.S. Pat. No. 4,728,965, issued to Kessler et al, Mar. 1, 1988. Digital data is used to modulate the duration of laser on-time or intensity as a laser beam is scanned by a rotating polygon onto the imaging plane. Such raster scan systems typically use red, green, and blue lasers. Unfortunately, as with CRT printers, the laser based systems tend to be expensive, since the cost of blue and green lasers remains quite high. Additionally, compact lasers with sufficiently low noise levels and stable output that allow for accurate reproduction of an image, without introducing unwanted artifacts are not widely available. Commercially available laser scanner systems tend to write images onto movie film at a speed of 3 to 10 seconds per frame and have been used primarily for special effects lasting only tens of seconds. For digital mastering of full-length feature films, a throughput of about 2 frames per second is needed for minimum efficiency, while real time (24 frames per second) would be preferable.

In an effort to reduce cost and complexity of printing systems, avoid reciprocity failure, and increase the throughput of the writer; alternative technologies have been considered for use in digital printing. Among suitable candidate technologies under development are two-dimensional spatial light modulators. Two-dimensional spatial light modulators, such as the digital micromirror device (DMD) from Texas Instruments, Dallas, Tex., or liquid crystal devices (LCD) can be used to modulate an incoming optical beam for imaging. A spatial light modulator is essentially a two-dimensional array of light-valve elements, each element corresponding to an image pixel. Each array element is separately addressable and digitally controlled to modulate light by transmitting or by blocking transmission of incident light from a light source. A liquid crystal spatial light modulator does this by changing the polarization state of light. Polarization considerations are, therefore, important in the overall design of support optics for a spatial light modulator.

There are two basic types of LCD spatial light modulators currently in use. The first type developed was the transmission spatial light modulator, which, as its name implies, operates by selective transmission of an optical beam through individual array elements. The second type, a later development, is a reflective spatial light modulator. The reflective spatial light modulator operates by selective reflection of an optical beam through individual array elements. A suitable example of an LCD reflective spatial light modulator relevant is one that uses an integrated complementary metal oxide semiconductor (CMOS) backplane, allowing a small footprint and improved uniformity characteristics.

Spatial light modulators provide significant advantages in cost, as well as avoiding reciprocity failure by increasing the total time each pixel is illuminated. Spatial light modulators have been proposed for a variety of different printing systems, from line printing systems depicted in U.S. Pat. No. 5,521,748, issued to Sarraf, May 28, 1996, to area printing systems described in U.S. Pat. No. 5,652,661, issued to Gallipeau et al, Jul. 29, 1997.

A single spatial light modulator, such as a Texas Instruments digital micromirror device (DMD) as shown in U.S. Pat. No. 5,061,049, issued to Hornbeck, Oct. 29, 1991, can be used for digital printing applications. One approach to printing using the Texas Instruments DMD, shown in U.S. Pat. No. 5,461,411, issued to Florence et al., Oct. 24, 1995, offers longer exposure times when compared to laser/polygon or CRT writers. Thus, the reciprocity problems associated with photosensitive media during short periods of light exposure are eliminated. However, DMD technology is both expensive and not widely available. Furthermore, the DMDs that are currently available lack the aspect ratios required for printing multiple image formats.

All of the above methods of image recording have drawbacks. Some do not address color image recording, some require that the photosensitive media be held in place for a period of time, during image exposure. The modulation and exposure schemes described in these examples are very demanding and complex. Area array modulators in particular suffer from limited pixel count, both horizontally and vertically, which restricts the achievable maximum pixel count.

As described in U.S. Pat. No. 6,478,426, issued to Druzynski et al., Nov. 12, 2002, a two-dimensional spatial modulator printer capable of high-speed and high quality image recording is described. However, this implementation also suffers from limited pixel count. Various attempts to optically stitch together multiple modulators to increase maximum pixel count suffer from pixel registration and alignment errors, device variability, and optics and illumination issues.

Gelbart, in U.S. Pat. No. 5,132,723, issued Jul. 21, 1992, and U.S. Pat. No. 5,049,901, issued Sep. 17, 1991, teaches a novel way to use a two-dimensional spatial light modulator that overcomes limitations of vertical pixel count and also does not require the media to be stopped for a period of time during image exposure. However, the Gelbart invention lacks the ability to introduce color.

Other patents, e.g., U.S. Pat. No. 6,686,947 issued to Druzynski, Feb. 3, 2004, teach sequential color across the modulator, however, non-continuous motion and LCD latency slow down the process. Also this disclosed invention suffers drawbacks in that it cannot currently write 1556 lines as defined by the Cinemascope SMPTE format. The DMD devices currently mentioned have 2048×1024 or fewer pixels and also cannot directly write a large image without using multiple devices, which introduces alignment, illumination, optics, electronics and calibration issues. Other contemplated future micromirror devices will probably have 2:1 or 16:9 ratios and suffer similar drawbacks.

U.S. Pat. No. 6,292,252 issued to Frick et al, Sep. 18, 2001, teaches a rudimentary color imaging system for writing strips using a DMD device, but the use of a color filter wheel introduces another moving element which does not allow for properly synchronizing color and image movement with the photosensitive medium's movement. What is needed is an invention that overcomes these deficiencies in a single system, specifically, a high-speed color printer that prints on photosensitive mediums such as movie (motion picture) film.

### SUMMARY OF THE INVENTION

A high-speed writer is disclosed that is suitable for continuous writing of data, such as writing onto motion picture film stock. Such a system has a continuous motion transport with servo position sensing, tied to the image advance mechanism of a two-dimensional spatial light modulator, such as a micro-mirror display. For a color version, the two-dimensional spatial light modulator is illuminated by RGB light as shown, and RGB levels and or number of illuminated rows are adjusted to provide for proper exposure.

### ADVANTAGES OF THE INVENTION

Since the present invention allows for multiple colors, on a single modulator there is no need to provide for multiple modulators, thus reducing cost and complexity.

In addition to a film image writer, the concept is highly suited for data on film writing. Black and white data writing, such as microfilm, has been prevalent for a long period of time, but the addition of a few color values in each of the color records dramatically increases the amount of information that can be encoded.

These and other aspects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a schematic diagram of an apparatus for printing image frames corresponding to a motion picture film sequence in accordance with the present invention;

FIG. 2a is a schematic diagram showing in greater detail the optical assembly of the apparatus in FIG. 1; and

FIG. 2b is a diagram showing an exemplary depiction of separately spaced red, green, and blue exposure zones; and

FIG. 3a is a schematic diagram showing the individual color exposure zones on a two-dimensional spatial light modulator; and

FIG. 3b is a graphical diagram of a potential reflected optical power distribution from the two-dimensional spatial light modulator; and

FIG. 4 is a schematic diagram of print engine wherein the light modulator is a D-ILA or similar LCOS device; and

FIG. 5 is a schematic diagram showing in more detail a variation in the illumination system of the optical assembly of the apparatus in FIG. 1 wherein the source of illumination is a lamp; and

FIG. 6 is a schematic diagram of a print engine, wherein the light modulator is a transmissive device, such as a TFT-LCD; and

FIG. 7 is a schematic diagram of a print engine, wherein the modulator is a direct illumination source, such as an OLED device.

### DETAILED DESCRIPTION OF THE INVENTION

Image recording systems write digital data onto photosensitive media by applying light exposure energy. Such energy may originate from a number of different sources and may be modulated in a number of different ways. Image recording systems can be used for digital printing, whereby digital image data is used to print an image onto photosensitive paper or film. This invention specifically relates to the high-speed (multiple frames per second) writing of digital image data onto 35 mm color movie film.

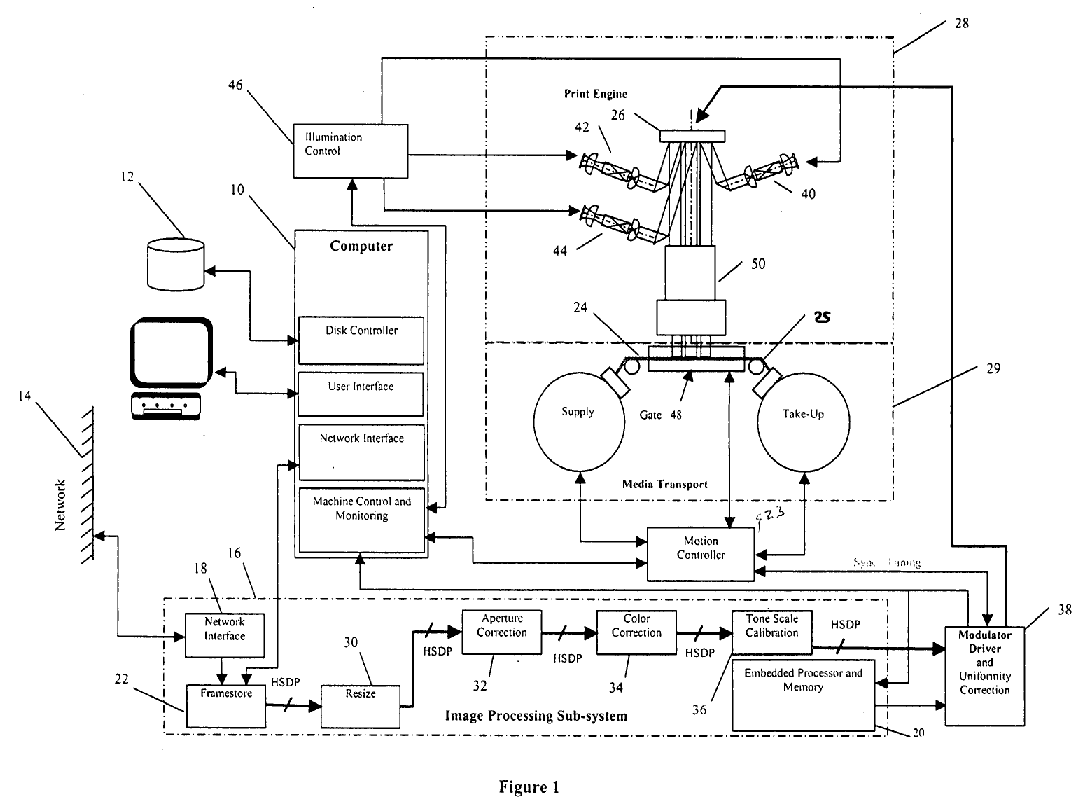

Turning now to FIG. 1, an apparatus is shown for printing at least three separable image planes from a digital image file of a motion picture where the digital image file may be stored on a computer's 10 local disk 12 or on any convenient digital file storage means accessible to the computer where such means could be on an external network 14 storage means. As will become clearer, the digital image file will be used to activate a two-dimensional spatial modulator 26 to provide digital image planes in three separate and distinct exposure zones corresponding to the red, green and blue image color records, for example.

Three image plane zones on the modulator are separately illuminated in a predetermined area ratio by red, green and blue LED illumination systems 40, 42, and 44. Each individual image plane zone is further actuated in a scrolling fashion to provide a portion of the required image at each individual column or row of the modulator in synchronization with corresponding motion of the photosensitive medium 24 as provided by the media transport 29.

The media transport 29 continuously moves the photosensitive medium in synchronization with the display of the digital images on a two-dimensional spatial light modulator. Frame synchronization feedback 25 provides medium positional information to the motion controller 23 to insure that the recorded images are exposed corresponding to the digital image file. Alternatively, the same system can be used to write data files instead of images. The written record can be any number of lines in length, due to the scrolling of the data down the rows of the device. For simplicity, the writing or recording of images is described herein, but the concepts embodied can be applied to continuous data recording as well.

Network interface 18 provides a common entrance point for the digital image file to be retrieved from the external network, whereas image files from the local disk enter directly into a framestore 22. The apparatus responds to the digital image file that contains discrete digitized color motion images or discrete digitized black and white motion images from which are produced light or visual images to be recorded on the photosensitive medium. The light images correspond to at least one or more separable monochromatic or color image records from the digital image file of the color or black and white image frame.

Digital images can be created from the output of a digital motion or still image camera or by computer-generated graphics or by digitally scanning photographic images off of a photosensitive medium. The means of storing digital images are also varied and include storage on compact optical disk, magnetic tape, or traditional computer disks. Once stored in a file they are accessible to computer systems manipulating, editing, and viewing. The digital images, when created and stored, are stored in some standard graphical image format such as JPEG, JPEG2000, TIFF, MPEG, MPEG2, or DPX. If the file is digital data, again a common format should be used. A format defines how the digital data should be interpreted in order to reconstruct the image or data. A series of images, each called a frame, which differ from each other in a small and ordered sequence and viewed in this sequence at some specific frame rate, will give the effect of motion to an observer.

FIG. 1 includes an activatable two-dimensional spatial light modulator, contained within an optical assembly called a print engine 28, having predetermined pixels in which different colored monochromatic visual images corresponding to each motion picture frame. Each pixel can be selectively activated.

Exemplary two-dimensional spatial light modulator devices are manufactured by Texas Instruments of Dallas, Tex., Victor Company of Japan, Limited (JVC), Three-Five Systems, Inc., Tempe, Ariz. and others. Texas Instruments specializes in modulators of the Digital Light Processing (DLP)™ style, including the Digital Micromirror Display (DMD)™, which is an optomechanical device that is comprised essentially of addressable columns and rows of reflective elements. In this type of device, the reflective elements are tilted to differing angles to produce an image. Other device manufacturers primarily produce devices of the Direct Drive Image Light Amplifier (D-ILA) type, which also has columns and rows of addressable pixels, but relies on polarization of the modulated light to form the image. Still other devices are known as transmissive type or TFT-LCD (Thin Film Transistor—Liquid Crystal Display) modulators. There are many manufacturers of these devices including Samsung Semiconductor, San Jose, Calif.

Unique among the various types of modulators is the active matrix OLED (Organic Light-Emitting Diode) such as those produced by Eastman Kodak Company, Rochester, N.Y. and Sanyo, Japan. This type of device is novel in that they are self-luminous and don't require the use of polarizers, uniformity optics or light sources.

The Texas Instruments DMD device currently provides for the most effective use of available light, but is limited in resolution to about 2048 pixels per row (known in the industry as 2k resolution) due to process limitations. Reducing the size and pitch of such micromirrors is the challenge faced by the manufacturer. Furthermore, the move today in the display industry is to the 16:9 (wide screen) aperture format, whereas the motion picture industry utilizes the 4:3 and 16:9 apertures among others. The SMPTE 59-1998 standard defines the apertures used on 35 mm motion picture film. Having the ability to create images of the highest possible resolution in a variety of aperture ratios, without suffering the limitation of the modulators native aperture ratio is one aspect that makes the present invention novel. Dithering of the modulator increases the usable pixel count.

The total active pixel area of the two-dimensional spatial light modulator is divided into three distinct and separate zones, corresponding to the red, green and blue records contained within the image data. The total area of each zone is apportioned according to the amount of exposure required for each color record.

The combination of the magnitude of the light power output and the time duration is known as the film exposure value. The log of the film exposure value determines the density of the images on the photosensitive medium. The standard equation D=log H is very commonly used in the photographic industry to define this relationship, where D equals density and H equals exposure in lux-seconds. Controlling the magnitude and time of the illumination sources limits the maximum density for each color plane, respectively, while the two-dimensional spatial light modulator controls, dynamically, the density of each pixel for each color plane, respectively, within this limit of the exposure control.

By understanding this relationship, it will be possible to determine the exposure contribution from each row or column on the modulator. Other factors that must be considered are column or row refresh rate and media transport rate to avoid causing streaks in the completed image.

In the print engine for a three color RGB writer, light from the red, green, and blue LED illumination systems 40, 42 and 44 is collimated and sized so as to provide uniform illumination to their respective areas on the two-dimensional spatial light modulator. The two-dimensional spatial light modulator responds to incident light in order to create visual images that are recorded on a photosensitive medium.

In order to activate two-dimensional spatial light modulator, the following circuitry responds to the stored digital image as follows. A digital color image frame is comprised of one or more visual image planes each of which is a composite of pixels arranged in two dimensions. Each pixel is created on the medium using digital data from one or more of the separable monochromatic color records corresponding to one or more of the separable color image planes on the photosensitive medium. In the case of black-and-white images intended for black-and-white photosensitive medium there is only one monochromatic image plane; therefore, only one data file record is required. In the case of true color images, there are generally three data file color records and three image planes on the photosensitive medium. Another variation used in the motion picture industry is color separations where each color record is written out either sequentially or on three separate film reels.

Each color record defines the densities of the pixels for that color plane. Density might be measured, for example, in a metric such as Status M, Status A, or printing density (DPX) in the case of motion picture film, depending on the types of photosensitive medium to be used. The density of the pixel can be represented by a value of some magnitude, which is referred to as the color bit depth. Such a magnitude can be represented by a digital value of n bits. An 8-bit value has a bit depth of 256 discrete density levels, and a 10-bit value has 1024 discrete density levels.

The digital image is transferred one frame at a time to the framestore in the image processing sub-system 16 from storage means 12 or 14 in FIG. 1. The image processing sub-system provides a collection of processing functions that are configurable and controlled by the embedded processor 20 shown in FIG. 1. The processing of data requires a very high-speed data path which may or may not exist within the general computer. The image processing sub-system may be a specialized high-speed external computer or a peripheral processing card or collection of cards within the computer. High-speed processing elements such as FPGAs, DSPs, or ASICs might be employed to process the image data according to firmware program control.

Framestore 22 can hold several images at any one point in time depending on a number of design and operational needs, but generally only one image at a time is processed for printing. Framestore 22 might perform simple data manipulation, such as line reversal for printing positive or negative images where the physical placement of the image on the photosensitive medium between a positive and negative image frame, is different.

Each separable color record of a frame is then transferred from framestore 22 into one or more image processing elements as is dictated by the needs of the user. Image processing sub-system 16 includes resize 30, color correction 34, and tone scale calibration 36. Image processing subsystem 16 manipulates the digital image data to achieve certain results on the photosensitive medium. These techniques are known in the art and can involve the process of resizing the digital image to increase or decrease the physical aperture size on the photosensitive medium. Another process known as aperture correction 32 is used to correct pixel defects that may have occurred during data transmission of the digital image data. Aperture correction may also be used to sharpen or blur the image.

The imaging area of a two-dimensional spatial light modulator is a composite of pixel sites similar to the aperture format of an image frame. The number of pixel sites and two-dimensional spacing of them defines the resolution of the device. It is very important in high resolution imaging applications that all sites have uniformly reflective transfer characteristics. Ideally, all pixels in the modulator should have equal reflectivity over the full effective dynamic reflectance range within some specified tolerance. If this situation is not met, objectionable artifacts can result and be noticeable on the photosensitive medium. For example, relative variations of 0.002 density on motion picture film negative (e.g. Eastman Kodak Company ECI 5242) will be perceived as objectionable by the human observer when recorded on print film and projected on a screen. This variation on film of 0.002 density can be the result of reflection variations in pixel sites of ½%. Reflectance variation in the light modulator is a static characteristic that is the result of process variations at the time of manufacturing.

Referring again to FIG. 1a, a modulator driver/uniformity correction module 38, includes a predetermined correction factor for adjusting gain and offset for each pixel within the modulator to reduce the reflectance variations of the image processing sub-system to within specified limits at the time of printing the image. A patent of interest for its teachings in this area is U.S. Pat. No. 5,047,861, issued to Houchin et al, Sep. 10, 1991. In this patent, the method and means of providing for this correction can be implemented by programmable look-up tables. One method of deriving the correction factors for each pixel would require printing a full aperture flat-field image on the photographic medium with no correction compensation applied to the LCD modulator. A flat-field image is a digital image wherein all pixels are of the same density. It is preferred that the density of the image is approximately mid-scale. The flat-field image on the medium is digitized at the maximum image aperture size and resolution to produce density data for all pixels in a color plane. A high-resolution scanner or microdensitometer can be used to digitize the image. A resulting uniformity data map digital file is created from which relative variations in pixel reflections on the modulator can be determined. The data is converted from log space (density) to linear space (intensity) and the median reflectance level is determined. The correction factor for each pixel is the percentage deviation from the median point of each pixel in a color frame. These correction factors are applied to the image data by the modulator driver/uniformity correction module 38 at the time of printing an image.

The correction factors from the uniformity data map could be used to correct the image, if applied to the digital image file directly while the data is in log space (density). This would require more processing time and digital file storage or modifications to the original digital image file, which may or may not be desirable.

The reflectance correction values used by the uniformity correction could vary as a function of the specific pixel on the modulator, the color bit depth of the pixel, and as a function of the specific color plane. The reflectance of the pixel site on the modulator is controlled by the density code value in the digital image file. It might be necessary, therefore, to provide many correction values where the number of correction values equal the product of the number of pixels in a modulator, the number of separable color planes, and the color bit depth of each pixel. This represents a very large number of discrete values that are stored on the computer and loaded to the modulator driver at power up. There are a number of more efficient means of applying this correction, which is known to those skilled in the art. The corrected image data is presented to the modulator in accordance with the specific requirements of the device manufacturer.

In a preferred embodiment, there are at least three arrays of spaced red, green, and blue light-emitting diodes LED's, 40, 42, and 44 called the illumination sources. One controls the absolute light power output of each array as well as the time duration that the arrays are turned on and radiating light.

These light-emitting diodes (LEDs) are controlled by the following elements. The LEDs emit radiant energy in proportion to the forward current through a diode junction. The relationship between forward current and emitted radiant energy is very close to being a linear function. The specific devices and manufacturers limit the maximum forward current. A typical maximum continuous value for such a device manufactured by Nichia America Corp. is in the range of 30 to 50 milliamps, with radiant power output of approximately 3 to 5 milliwatts in the 400 to 700 nanometer wavelengths. These devices can be operated in a pulsed mode as long as the pulse duration and duty cycle are not exceeded. In the pulsed mode, a 50% increase in radiant output levels can be realized for the short duration of the pulse.

It is the function of the illumination control to control the illumination sources such that the computer under application software control can set any desired level of power output, within the limits of the devices. Input values to the illumination control could be an analog voltage from the computer for each color channel that represents 0 to 100% power output at the medium plane. In order to set the power output of the illumination sources to a specific value, a data profile of the response of input voltage versus power output would be generated and stored in the computer.

Illumination control 46 (shown in FIG. 1) controls the overall activity of the arrays in response to commands from computer 10. Under program control from the computer 10 and positional information from the frame synchronization feedback system 25, the photosensitive medium is positioned such that an unexposed area of the medium is located in a Gate 48 of media transport 29.

One or more color records of an image frame are singularly or sequentially scrolled to the modulator in unison with the media transport 29 and the feedback system 25. As the photosensitive medium is transported, a portion of the required exposure value for each individual line or row and color is applied creating a latent image of a single image line. As the medium is advanced the equivalent of one pixel, the process is repeated creating an additional exposure on the previous line, and making the first exposure on the next image line. Depending on the number of lines per zone, the first color line will eventually be transported to the next two color exposure zones, where the overlapping color exposure will be applied, until that images entire color record is completely exposed.

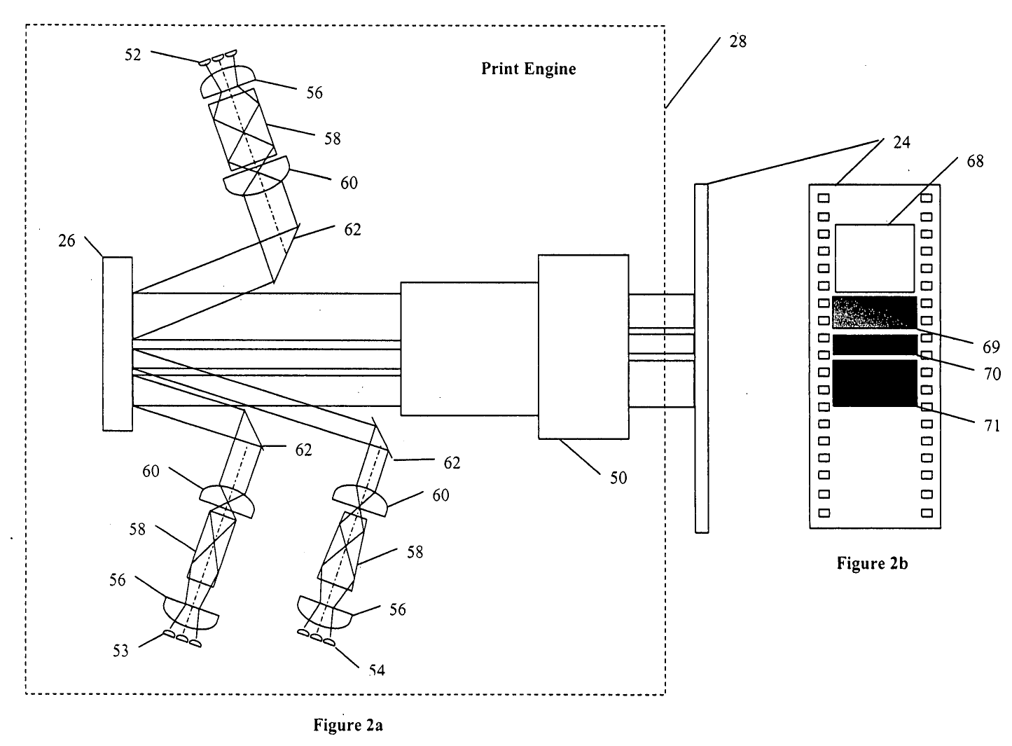

The print engine 28 is shown in more detail in FIGS. 2a and 2b. Turning now to FIG. 2a, the print engine 28 includes separately spaced red, green and blue illumination sources shown as red, green, and blue LED arrays 52, 53, and 54, readily available from a variety of manufacturers, which emit narrow wavelength ranges of light. The emitted wavelength ranges of the separately spaced LED arrays are specified to match the spectral sensitivity of the photosensitive medium to be exposed. The red, green, and blue LED arrays are actuated, depending on the color information contained in the digital image file, and in response to control signals provided by illumination control 46 (shown in FIG. 1), to expose the image on the photosensitive medium one color emulsion layer at a time.

Condensing and shaping lens 56 collects light and efficiently projects it along an optical path to uniformity optics 58. For FIG. 2a, surfaces internal to a glass cube (commonly referred to as an integration bar) cause total internal reflection (TIR) of the light and create a homogeneous beam for projection. Integrators serve to provide uniform illumination and shape the exiting beam into a rectangular aperture. There are other methods known to those skilled in the arts of optics and illumination for achieving uniform light including, but not limited to, “flies eye” uniformity lenslets, integration chambers of various shapes and sizes and mirror tunnels. Light exiting these integrators is conditioned by collimation optics 60 to produce a collimated, uniform beam.

To provide for a reduction in space requirements, first surface mirrors 62 are used to fold the collimated light beam for projection to the modulator, in this case a digital micromirror type. It is preferable that the light be presented to this type of modulator in an angled fashion, to avoid unwanted exposure. Image projection optics 50 subsequently collects the projected images and either minimizes or magnifies the image lines to obtain the desired image width and focuses it on the medium surface, registered within media transport system 29 and gate 48 previously shown in FIG. 1, thereby creating a latent image.

FIG. 2b is a preferred embodiment showing an exemplary depiction of the green, blue, and red exposure zones 69, 70, and 71, respectively, and a completed latent image 68 created by the process described previously on photosensitive medium 24. It is noteworthy to recognize the variation in area between the three different color zones. This zone variation is to account for the variations in the spectral sensitivity of the color layers of the medium. In this case illustrated, more red exposure is required than blue or green and less blue exposure is required than green. This case is not uncommon with motion picture negative or inter-negative film emulsions. These areas may be adjusted by mechanical, illumination, or optics adjustments to account for various medium types.

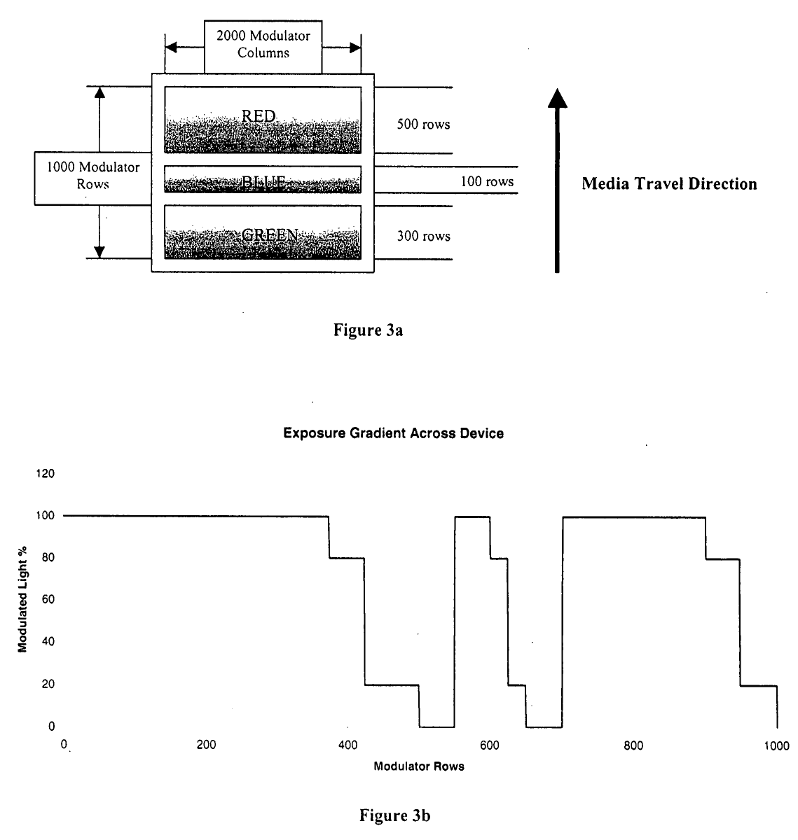

FIG. 3a shows the exemplary modulator zones and the exemplary number of allocated modulator lines per zone. For example, red comprises 500 modulator rows, blue 100 modulator rows, green 300 modulator rows. The gradients shown within the zones are a depiction of the reflected light projecting from each of the zones. The optional void zones shown between the exposure areas are shown as approximately 50 lines wide and forms lines of separation between the colored light and can be used to avoid unwanted scattered light from entering the exposure areas depending on the illumination system.

The number of allocated modulator lines per zone is determined mathematically by calculating the ratio of exposure required in the slowest emulsion layer of the photosensitive media versus the other layers, and the number of rows available on the modulator. This is preferred over zones containing equal numbers of allocated modulator rows due to optical efficiency.

FIG. 3b shows in graphical form the exposure energy created through a cross section of the individual zones. The reductions that are shown allow the user to apply some lesser exposures to assist in completing higher density areas of the image. Alternatively, the present invention can function with equal values for each line if properly calibrated. An alternative method of creating a variable exposure profile can be accomplished optically, for example, it is possible to incorporate a gradient neutral density filter, referred to as a step wedge, to cause a structured decreasing exposure profile for each color.

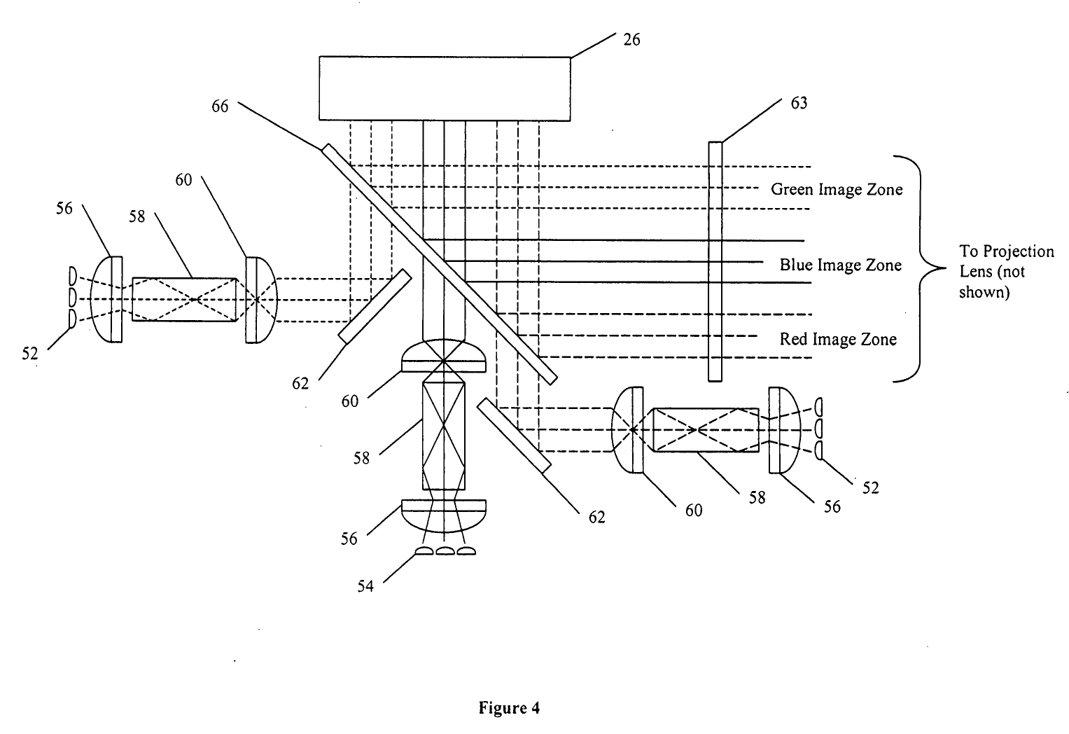

FIG. 4 shows another exemplary embodiment, wherein the modulator is a D-ILA or other LCOS device. Once conditioned by a light beam relay and focusing optics (uniformity optics 58 and collimation optics 60), the light enters a polarizing beam splitter 66 and intersects its internal surface, at which time the light is partitioned into two discrete polarities referred to as the “S” and “P” planes. Light in the “P” polarity reflects off the beam splitter's 66 internal surface at a 90-degree angle and is extinguished. Light in the “S” polarity is allowed to pass through beam splitter 66 and illuminates modulator 26 to produce an image of the motion picture frame.

The modulator is electronically activated in response to the digital image signal through the action of modulator driver 38 shown in FIG. 1. The modulator driver signals result in a proportional part of the uniformized and polarized light to be reflected off of the individual pixel sites of the modulator 26. The reflection percentage is in response to the digital image signal of modulator driver 38, and is, therefore, scene content dependent. During this reflectance, the “S” polarity light originally projected to modulator 26 is effectively rotated to the “P” plane which is, in turn, reflected at a 90-degree angle by the polarizing beam splitter 66 toward the imaging projection optics (not shown). As the image-bearing beam is reflected by the polarizing beam splitter 66, a small percentage of the image may become randomly polarized. The incorporation of output polarization optics 64 serves to reject this energy and increase contrast in the image.

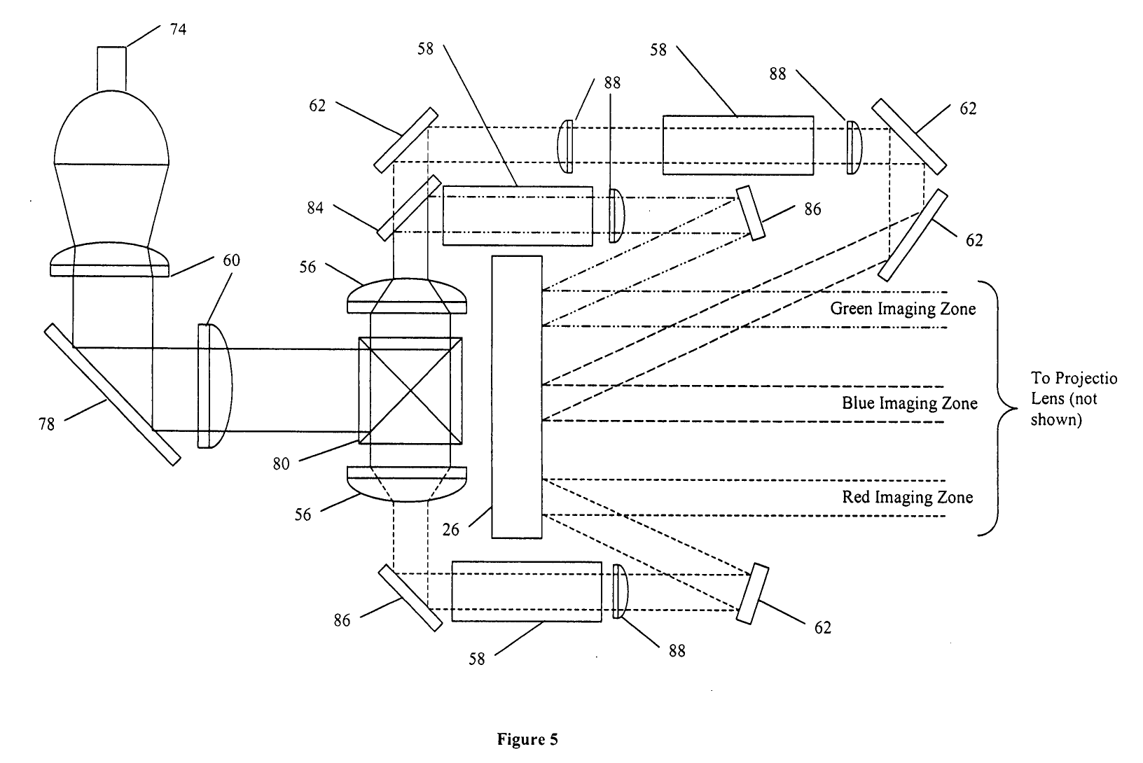

Another embodiment, which is a variation to the discrete LED array illumination sources, is shown in detail in FIG. 5. Turning to FIG. 5, a polychromatic (white) light source is used to provide illumination to modulator 26.

Collimation optics 60 captures the light emitted by lamp 74. Since, by its nature, polychromatic light contains a multitude of wavelengths, one should remove the harmful wavelengths, such as infrared light. High amounts of infrared energy may cause premature failure of modulator 26 and other optical components. Cold mirror 78 transmits this unwanted energy to an area where it may be extinguished while reflecting light in the visible wavelengths at a 90-degree angle to a second collimation lens for projection to dichroic prism 80.

The inner surfaces of four triangular prisms are coated with dichroic coatings that will either reflect or transmit particular wavelengths and are joined together to form a cube. Depending on the arrangement of these surfaces it is possible to separate selected wavelengths from the polychromatic beam. In FIG. 5, red energy is separated from the beam and is directed at a 90-degree angle to a receiving condenser lens 56. The remaining blue and green energy is reflected at an opposing 90-degree angle into their respective receiving condenser lens.

The separated red energy is projected along its optical path to uniformity optics 58 and relay optics 88 for projection onto first surface mirror 62. The mirror serves as a steering device to uniformly illuminate the modulator red imaging zone.

The combined blue and green beam exiting the condenser lens is projected along its optical path to a blue/green separation filter 84, where the green energy is reflected at a 90-degree angle to its uniformity and relay optical path for uniformly illuminating the modulator's green imaging zone.

The remaining blue beam is directed along the optical path to first surface mirror 62, where it is reflected at a 90-degree angle to its uniformity and relay optical path. Two first surface mirrors are needed in this example to direct the blue energy to uniformly illuminate the modulator blue imaging zone. As can be determined, this optical path will cause a loss in blue energy along the path, however, far less blue energy will be required to create the properly exposed latent image on camera negative or intermediate film stocks than, for example, red or green energy. Consequently, blue energy was selected to follow the longer path.

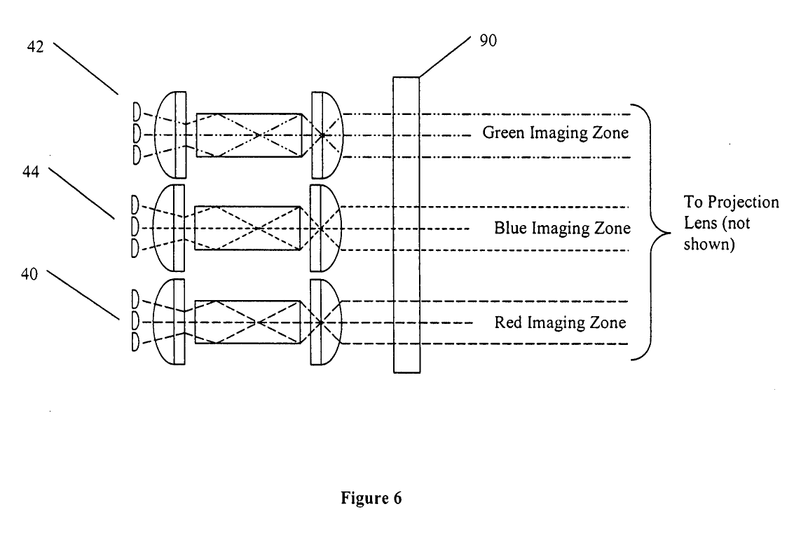

FIG. 6 shows another embodiment where the modulator is a TFT-LCD transmissive device. In this approach, the LED illumination systems 40, 42 and 44 previously described are positioned to provide uniform illumination that will pass through a TFT-LCD modulator 90 and is modulated to create a latent image on the photosensitive medium.

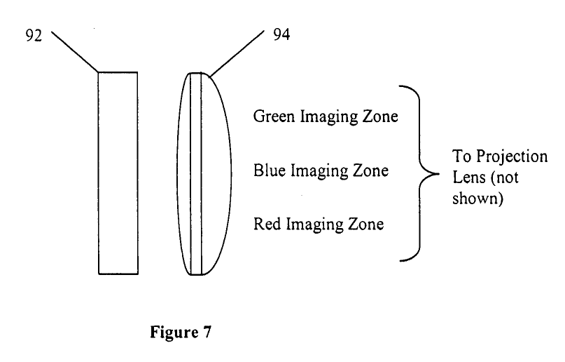

FIG. 7 illustrates another embodiment. The modulator is an active matrix OLED (Organic Light-Emitting Diode) device 92 and produces self-generated illumination and contains columns and rows of addressable pixels. Collection lens 94 collects the emitted image bearing energy and projects it to the projection lens (not shown). The projection lens in turn focuses and distributes the image bearing energy to the medium to create the latent image. The invention has been described in detail with particular reference to certain preferred embodiments thereof, but it will be understood that variations and modifications can be effected within the spirit and scope of the invention.

### PARTS LIST

10 Computer
12 Local disk
14 External network
16 Image processing sub-system
18 Network interface electronics
20 Embedded processor (central processing unit) electronics
22 Framestore electronics
23 Motion Controller
24 Photosensitive medium
25 Frame synchronization feedback
26 Two-dimensional spatial light modulator
28 Print engine
29 Media Transport
30 Resize electronics
32 Aperture correction electronics
34 Color correction electronics
36 Tone scale calibration electronics
38 Modulator driver/uniformity correction electronics
40 Red LED Illumination System
42 Green LED Illumination System
44 Blue LED Illumination System
46 Illumination control
48 Gate
50 Imaging optics (Projection lens)
52 Red LED Array
53 Green LED Array
54 Blue LED Array
56 Condenser Lens
58 Uniformity Optics
60 Collimation Optics
62 First surface mirror
64 Output Polarizer
66 Polarizing Beamsplitter
68 Completed latent image
69 Green Imaging Zone
70 Blue Imaging Zone
71 Red Imaging Zone
74 Lamp (Light source)
78 Cold Mirror (IR transmitting)
80 Color separation cube or plates
84 Blue/Green separation filter (dichroic plate)
88 Relay Optics
90 Transmissive TFT-LCD modulator
92 OLED Device
94 Collection Lens

What is claimed is:

1. A system for writing data with a high-speed area array modulation onto a photosensitive medium that is in continuous motion, comprising:
a) an illumination source including a plurality of individual colors;
b) an illumination optical element that distributes individual color onto distinct areas of the high-speed area array modulator, wherein each distinct area is proportionally related to the photosensitive medium's sensitivity to a corresponding color;
c) a high-speed area array modulator that rapidly modulates the plurality of individual colors in correspondence to the data on a pixel-by-pixel basis;
d) an output optical element to direct the modulated color light from the high-speed modulator onto the photosensitive medium; and
e) a frame synchronization shifter that synchronizes movement of the data to contiguous areas of the high-speed area array to the photosensitive medium while it is in continuous motion.

2. The system claimed in claim 1, wherein the high-speed modulator directly emits modulated colored light.

3. The system claimed in claim 1, wherein the high-speed modulator is an microelectromechanical system.

4. The system claimed in claim 1, wherein the data written to the photosensitive medium is selected from the group consisting of color image data, black and white image data, bit/byte data, color encoded bit/byte data or a mix of data types.

5. The system claimed in claim 1, wherein the photosensitive medium is selected from the group consisting of motion picture film, photographic film, and photographic paper.

6. The system claimed in claim 1, wherein the illumination source has three or more individual colors.

7. The system claimed in claim 1, wherein the illumination source colors are adjusted in intensity to properly expose the photosensitive medium corresponding to both movement of the photosensitive medium and the size of the distinct area of the high-speed area array modulator that are illuminated.

8. A method for writing data with a high-speed area array modulator onto a photosensitive medium that is in continuous motion, comprising the steps of:
a) illuminating the high-speed area array modulator;
b) distributing individual color onto distinct areas of the high-speed area array modulator, wherein each distinct area is proportionally related to medium sensitivity to a corresponding color;
c) rapidly modulating the plurality of individual colors in correspondence to the data on a pixel by pixel basis;
d) directing the modulated color light from the high-speed modulator onto the photosensitive medium; and
e) synchronizing movement of the data to contiguous areas of the high-speed area array to the photosensitive medium while it is in continuous motion.

9. The method claimed in claim 8, wherein the high-speed modulator directly emits modulated colored light.

10. The method claimed in claim 8, wherein the high-speed modulator is a microelectromechanical system.

11. The method claimed in claim 8, wherein the data written to the photosensitive medium is selected from the group consisting of color image data, black and white image data, bit/byte data, color encoded bit/byte data or a mix of data types.

12. The method claimed in claim 8, wherein the photosensitive medium is selected from the group consisting of motion picture film, photographic film, and photographic paper.

13. The method claimed in claim 8, wherein the illumination source has three or more individual colors.

14. The method claimed in claim 8, wherein the illumination source colors are adjusted in intensity to properly expose the photosensitive medium corresponding to both movement of the photosensitive medium and the size of the distinct area of the high-speed area array modulator that is illuminated.
